(19) United States
(12) Patent Application Publication
(10) Pub. No.: US 2019/0045755 A1
(43) Pub. Date: Feb. 14, 2019

(54) VIVARIUM SYSTEM

(71) Applicant: Karl ENGELHARDT, Feuchtwangen (DE)

(72) Inventor: Karl ENGELHARDT, Feuchtwangen (DE)

(21) Appl. No.: 16/075,653

(22) PCT Filed: Feb. 3, 2017
(86) PCT No.: PCT/DE2017/100079

§ 371 Date: Aug. 5, 2018

(30) Foreign Application Priority Data
Feb. 6, 2016 (DE) 10 2016 102 107.5

(51) Int. Cl. A01K 63/00; F16B 1/00; A01K 31/06; A01G 9/02; A01G 9/12; A01G 7/04; A01K 63/04; A01G 9/24; A01K 63/06; A01K 29/00; A01K 45/00; H01F 7/02

(52) U.S. Cl. CPC A01K 63/003; F16B 1/00; A01K 31/06; A01G 9/02; A01G 9/122; A01G 7/045; F16B 2001/0035; A01G 9/246; A01K 63/065; A01K 29/005; A01K 45/00; H01F 7/02; A01K 63/047

(57) ABSTRACT

The invention relates to a vivarium system which is composed of combinable individual containers (II) and plant climbing aids and is provided with magnetic adhesion to ferromagnetically equipped walls and ceilings (I) having a painted and/or plastered and/or lined surface. Vitalization of inner spaces, facades and free spaces by a module system that can be combined in a variable manner and is composed of small biotopes such as aquariums, terrariums, aviaries, paludariums and other vivariums for small animals, birds, insects and plants, for the fastening to walls and ceilings without causing damage to the visible surfaces by drillings for dowels, pins and screws and without rigid bonds with the fastening base.

The invention relates to a combinable system of containers for small biotopes, plant growth supports, and wall designs according to the preamble of claim 1.

The previously known aquaria, terraria, paludaria and climbing systems all have the property that they have to be placed either on the floor, on cabinets or other storage areas or shelves or have to be fixed by a strong connection such as gluing, dowelling or screwing to stand frames, cross members, brackets or walls.

The invention is based on the object of presenting a system that can be extended and connected in stages from a small individual cell to a larger complex structure, even with different kinds of small biotopes, and can also be variably adapted to changing conditions in interior rooms in a space-saving manner without any great additional effort for attachment, clearing up and secondary work. In addition, animals can be kept in a more species-appropriate manner even in small vessels, since small animals are provided with an extended and more diverse habitat because they are able to move around between vessels.

Aquaria, terraria, paludaria and plant containers are available in sizes from a mini container with integrated filtration, ventilation and lighting system through simple or more complex shaped large containers up to a whole-room system with display windows, in many variations. With the vivarium system invented here, self-supporting systems can be spread on to the wall area or separate, exclusively wall-based systems can be constructed. No additional or other provisions have to be made for this purpose, apart from the previous installation of an invisibly integrated presentation wall surface, as described in patent no. DE 10 2004 049 206.

The individual modules are subdivided into containers, bottom and lid parts, connecting tubes, holders and supports, in each of which the retaining magnets and the supply systems for electricity, water and nutrients, and optionally the discharge pipes for waste and fecal matter, are integrated invisibly or with an esthetic design.

The essential novelty lies in the design freedom and variability and the configuration as a biotope network or chain system with different habitats by simple, non-destructive attachment to conventionally designed and/or wipeable and ferromagnetically coated wall surfaces and/or in association with self-supporting components and/or in combination with other reversible wall designs and/or wall uses from a magnetic bulletin board with wipeable wall decoration or inscription, to presentation, signage, play, depositing and storage functions.

The small biotopes are supplied with electricity, water, oxygen and nutrients along the strings of biotopes by way of conduits integrated into the connecting tubes from a central auxiliary container with power supply technology, which is set up near to a socket; either as a self-contained processing system with freshwater and wastewater tanks or as an automatic open system connected to a domestic water supply and drainage. The automatic processing of the substrate medium and atmosphere medium using air and water is based on known methods of aquarium and vivarium care, hydroponics and floriculture.

In general, a small-scale system composed of 1 to 5 containers with strong magnets integrated on the back is attached to a wall unit or presentation wall that has been previously provided with ferromagnetic properties using iron plaster or sheet steel plates. Multiple individual containers are connected using multifunctional tubes. These generally transparent tubes serve to connect the biotopes, are sized to allow fish or small animals to pass through and have electrical cables with contacts and/or fine channels with airtight and watertight terminations integrated in a largely invisible or unobtrusive manner.

Large-scale systems composed of magnetic wall elements and/or free-standing and/or ceiling-hanging container combinations can also be constructed, among which climbing plants also grow by means of simple climbing aids. Thus, interior spaces can be enlivened in a wide variety of ways and expansions or modifications can be carried out without the need for any unattractive holes, Halfen rails, wall or ceiling hooks or for any repair or restoration work to be undertaken afterwards. In this way, very vivid, extremely interesting and variable interior designs can be achieved with high-quality, as well as multifunctional, wall areas (presentation, projection, magnetic bulletin board, whiteboard etc.) in a kind of living building block system. Furthermore, individually fabricated add-ons can also be integrated into this basic system.

The vivarium elements can be arranged in a flat, spatially angled, step-shaped, network-like, spiral-shaped, arc-shaped, circular or cylindrical manner. Multiple connection apertures that are perforated and/or prefabricated in a grid offer a choice here between an aligned, slightly offset or highly offset arrangement or rotation.

The overall system is supplemented by magnetic holders, for rods, ropes, nets, hoses, hooks, baskets and other accessories, for fixing to ferromagnetic wall and/or ceiling and/or floor surfaces, as well as by stands or spacers for the free arrangement of interconnected individual containers.

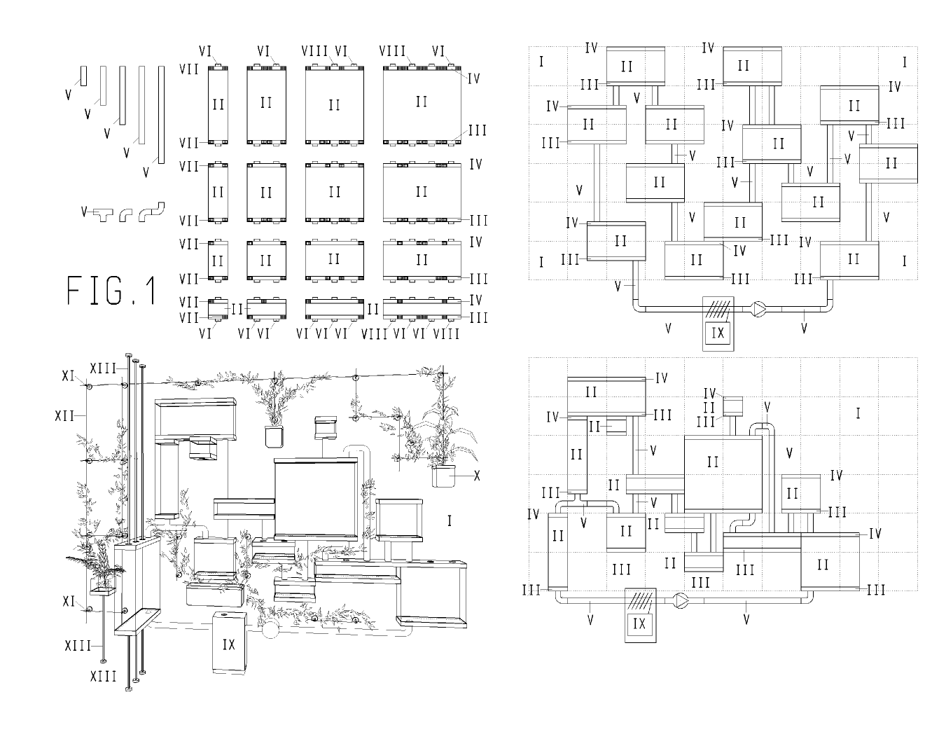

The system drawing FIG. 1 shows the rudimentary ways of varying the main components in a grid design for two configured system examples.

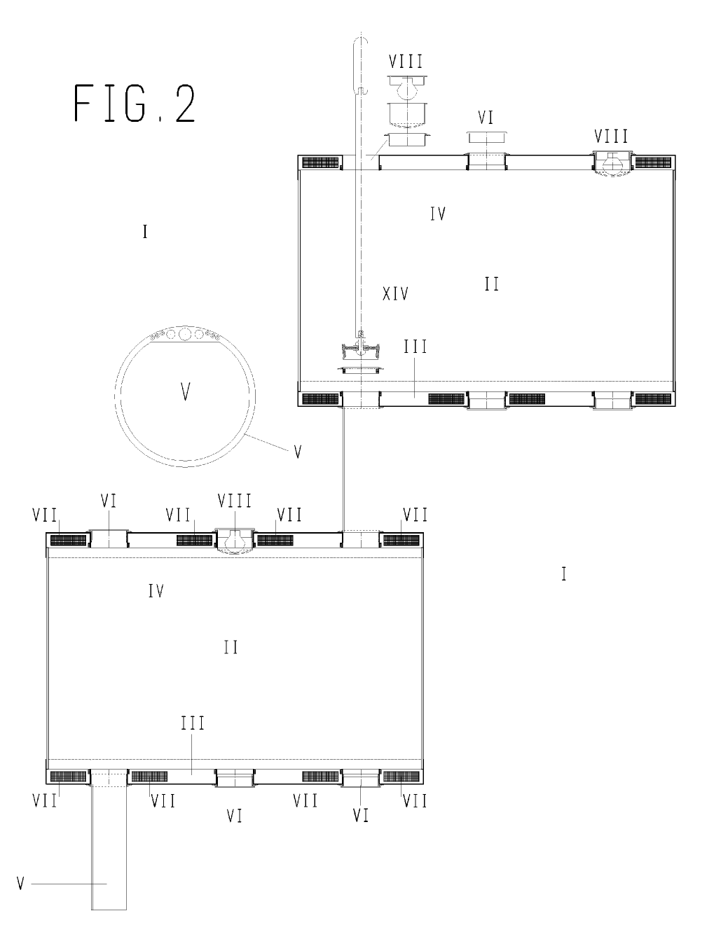

FIG. 2 shows two connected containers (II) in section, with integrally formed, water-tight connection apertures in the bottom part (Ill) and the lid part (IV), connecting tubes with electrical cables and transport channels (V) shown in the tube cross-section, air- and water-tight aperture cover (VI), the arrangement of the strong magnets (VII), functional accessories (VIII) for apertures provided with power supply technology or other services and simple tools for maintenance when the biotope containers are filled, for partial emptying or cleaning and for blocking off the connection apertures to prevent small animals from escaping.

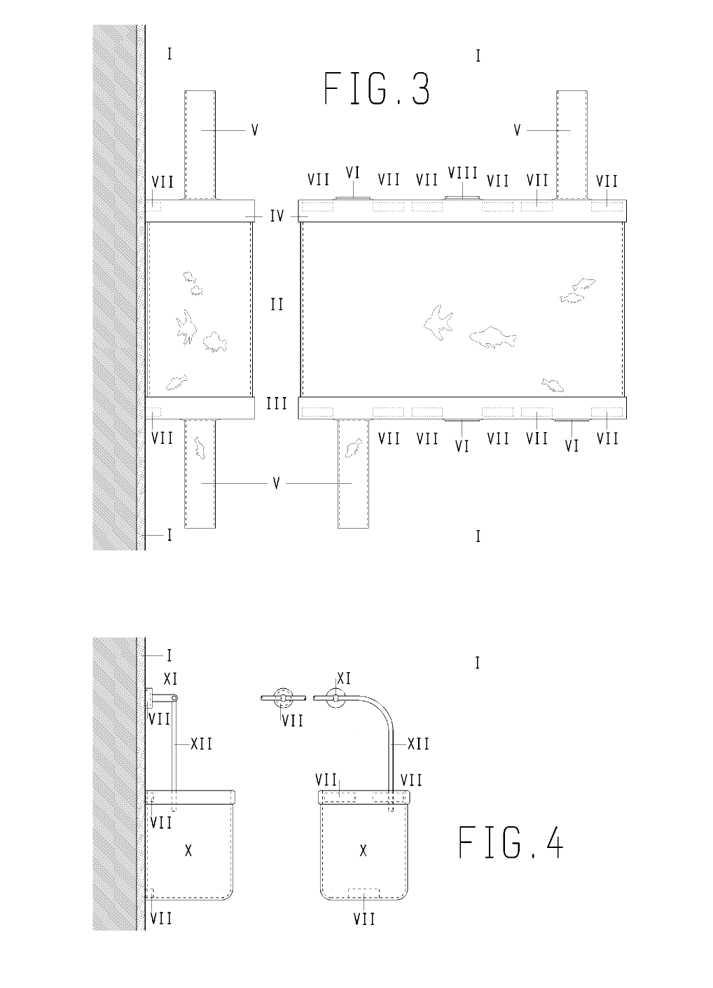

The system drawing FIG. 3 shows the front and side view of an aquarium container with 6 connection openings, for example in the form of a cuboid glass container (II) with, bonded in a load-bearing manner, a bottom part (III) and a lid part (IV) made of (stainless) steel, attached by means of the integrated strong magnet (VII) to a ferromagnetic, ferrous wall coating (I).

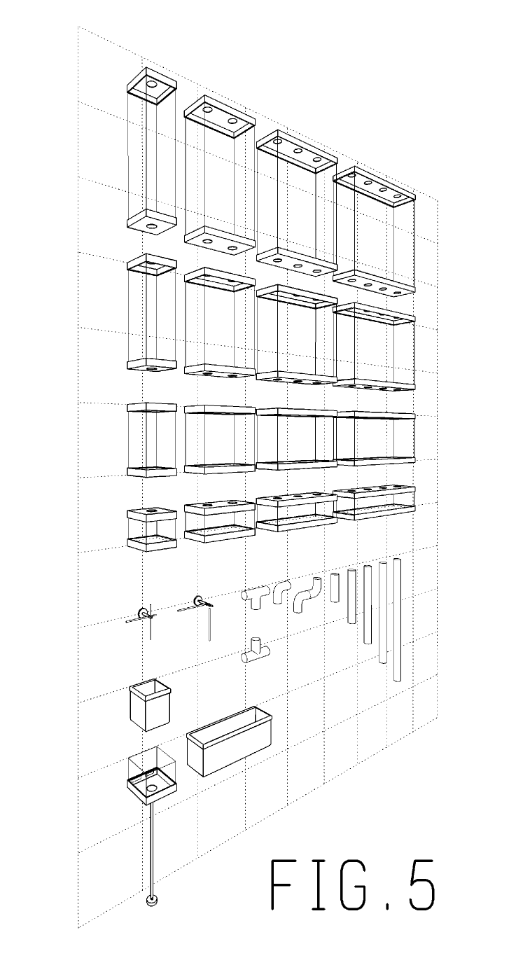

FIG. 4 shows a simple container (X) made of glass, ceramic or plastic with holding magnets (VII) integrated on the back and a simple magnetic holder (XI), here for example with an irrigation hose (XII), on the magnetic wall area (I).

The system drawing FIG. 5 shows an overview of the essential, schematic, individual components of the modular system in a grid.

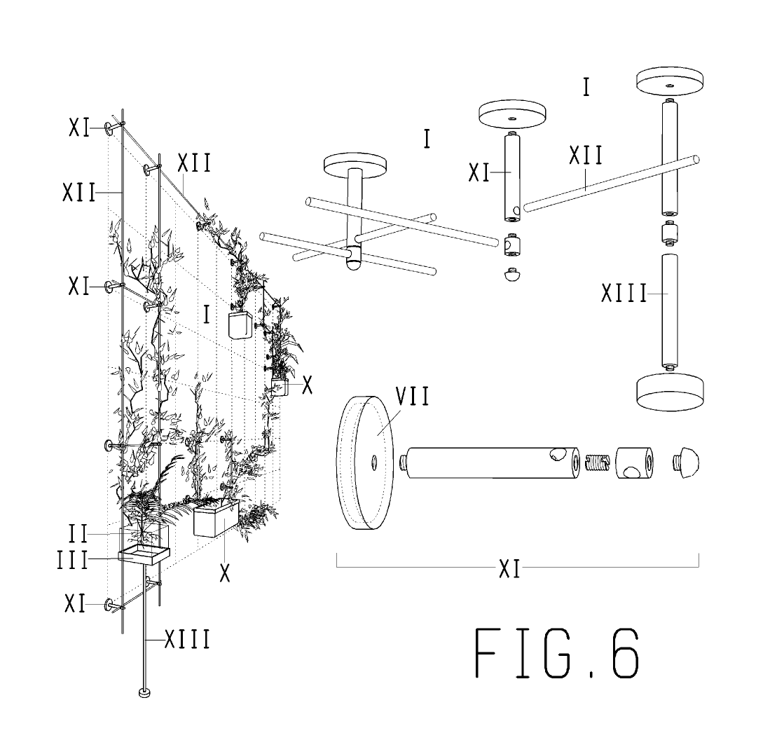

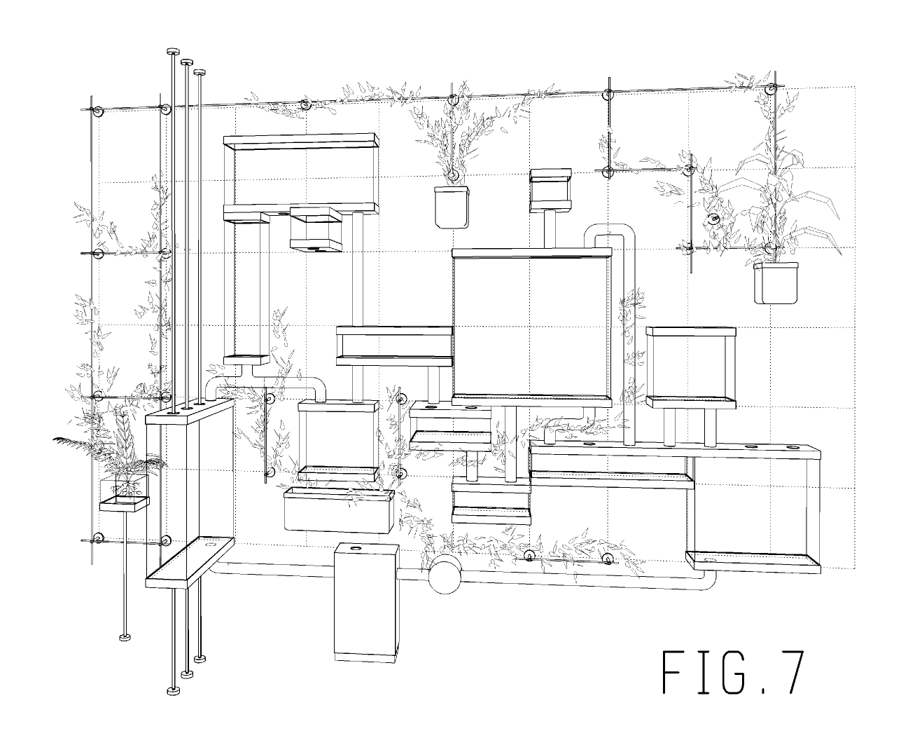

The system drawing FIG. 6 shows an exemplary embodiment solely for house plants, and the universal magnetic holder (XI) with a screw-in, rotatable retaining lug and a screw-in clamping cap as a visual finishing touch in an enlarged detail illustration, and the strong magnet (VII) embedded in the base disc as well as a holder connection (XII) which is to be inserted in the holes of the retaining lug. The extended variation as a vertical holder (XIII) is used for the additional fixing, in a minimalist manner, of shelves projecting further into the room, countertops and/or excessively heavy fittings or those which are docked on the wall in only a horizontal plane, such as the exemplary hydroponic culture vessel with a glass container attached only by magnets in the bottom of the vessel. In the case of ceiling mounting, magnetic iron materials are likewise installed in a tension-resistant manner in the surface of the ceiling to which the base discs adhere by means of strong magnets. This can be, but does not have to be, the case on floor areas.

The system drawing FIG. 7 shows a schematic exemplary embodiment with biotope containers adhering to the wall in a flat manner, said containers being connected by means of tubes and having climbing plants growing among them, which are planted in simpler magnetic pots, and which climb and grow along holders and rods in the rest of the wall area. Two smaller biotope containers project into the room in a self-adhesive manner, and a large biotope container is fixed to the wall only by a narrow side, for example, to prevent it from swinging, and is additionally secured with vertical ceiling hangers and/or feet.

In each of the 7 drawings in the figures of the annex, the references denote the following:
I > the ferromagnetic wall surface
II > the transparent biotope container made of glass, plastic or metal bars
III > the bottom part with connection apertures as a substrate trough and sand trap
IV > the lid part with connection apertures for lamps, sensors, pumps, filters etc.
V > the connecting tube with integrated electrical cables and transport conduits for supply purposes
VI > the leakproof bottom and lid closure and/or service part with no additional function
VII > an integrated strong magnet for sticking to ferromagnetic wall areas
VIII > the leakproof bottom and lid closure part with lamp, sensor, pump, filter etc.
IX > an auxiliary device with control, processing technology and central circulation pump
X > a single container (flower pot, basket etc.) with integrated holding magnets
XI > a combinable universal holder with a strong magnetic base disc
XII > a holder connection by means of a bar, rope, net, chain or hose etc.
XIII > a vertical multi-purpose holder with magnetic ceiling and/or base disc
XIV > a maintenance tool with screen or stopper for closing during filling

1. A vivarium system consisting of containers for small-scale biotopes such as aquaria, terraria, paludaria, aviaries, plant and floriculture vessels, climbing rods, and climbing ropes, characterized in that heavy-duty magnets are installed in each of the individual containers on the side faces in the region of the bottom of the vessel and/or in the region of the lid of the vessel, the field strength of said magnets being adapted to the respective total weight of the container when filled to the maximum for a reference magnetic holding surface, wherein in the region of the outsides of the resulting magnetic contact surfaces a thin adhesive coating made of silicone or rough, tough and resilient plastic is applied, which increases the friction on the adherent surface on ferromagnetic wall areas by nano-interlocking and/or adhesion and protects the wall surface from scratching.

2. The vivarium system according to claim 1,
characterized in that one or more apertures are integrated in the water-tight bottom parts and/or in the water-tight lid parts of each of the individual biotope containers, said apertures being provided with a peripheral seal in the insertion area and plug-in interfaces into which tubes with plug-in sleeves and plug-in contacts for electrical cables, as well as plug-in seals for small cross-section transport pipes running in the tube wall, as well as stoppers and plug-in functional parts, each with an appropriate, uniform cross-section and uniform insertion depth, are functionally inserted in a water-tight manner.

3. The vivarium system according to claim 1,
characterized in that the apertures in the individual containers are connected in a water-tight manner, using plug-in seals, by means of connecting tubes that are matched in terms of their length, branching angle, bending radius and plug-in diameter, through which small animals can walk, in predetermined grid increments of the overall system.

4. The vivarium system according to claim 1,
characterized in that the apertures in the bottom part or lid part of the individual containers are arranged at intervals that follow a square or cubic grid, wherein both for a horizontal and for a vertical combination, as well as when the individual containers are offset by one or more grid units, matching connection apertures which lie exactly opposite each other are obtained in each case. The external dimensions of the vessels here are selected such that the vessel exteriors are at a distance from the next aperture axis which is slightly smaller than half the grid width so that a narrow gap remains when individual containers are connected together horizontally and at the same time the connection apertures of containers arranged vertically above and/or below them are correctly aligned in a perpendicular direction.

5. The vivarium system according to claim 1,
characterized in that, in the straight, the curved and the branching connecting tubes, running parallel to the longitudinal tube axis, insulated copper wires with plug-in contacts at the ends and, parallel thereto, transport channel conduits with internal diameters of a few millimeters and plug-in seals at the ends, run, which are adapted to ensure the rapid flow of nutrient solutions and processing liquids as well as air and gases in a permanently leakproof manner.

6. The vivarium system according to claim 1,
characterized in that suitable electrical contacts and plug-in sleeves for the transport channel conduits are integrated at appropriate intervals in the connection apertures in the individual biotope containers for the connecting tubes according to claim 3, which in turn lead by way of water-tight conduits to the contacts of the functional interfaces in other apertures with functional inserts or to functional parts installed in the biotope container, or are passed through as a bypass.

7. The vivarium system according to claim 1,
characterized in that the overall system which is divided into one or more individual biotope containers is connected together by way of one or more assignable apertures and tubes in such a way that the flow of the biotope water or the passage of the biotope air and the supplying of the individual biotope sections with nutrients or physical-chemical auxiliary fluids take place in structures which are lined up in sequence or in parallel and which are controlled and supplied either individually or in groups via a modularized individual or central control system with an electrical bus system. Electronic control circuits which are kept extremely small are separated into individual modules here by plug-in interfaces and are provided with their own interfaces, with which lamps, pumps, fans, thermostats, heaters, sensors, valves, cameras, spectrometers, step motors, and displays are controlled.

8. The vivarium system according to claim 1,
characterized in that the apertures on the top and bottom of the individual biotope containers are positioned in perpendicular alignment one above another so that an associated rod-shaped or tube-shaped tool can be inserted from top to bottom or from bottom to top, with which a magnetically adhering elastic screen with a rubber seal edge or a screwed-on stopper made of flexible rubber whose flat cylindrical outer surface is slightly conical towards the stump end can be inserted in a watertight manner into one of the connecting pipe insertion apertures. The smaller stump diameter of the stopper here is slightly smaller than the inside diameter of the connecting tube insertion apertures and the larger stopper diameter is slightly larger than the inside diameter of the connecting tube plug-in apertures of the individual biotope container. The elasticity of the end stopper and of the plug-in screen edge is selected such that each of the two plug-in parts can be pressed through an empty aperture using relatively high crumple force and, when attached to the end of the rod-shaped insertion tool, can be inserted in the opposite aperture, even in a water-filled container, for maintenance purposes so that the elastic stopper creates an internal seal or the inserted elastic screen edge adheres firmly on the ferromagnetic aperture edge by means of integrated magnets in such a way that small animals cannot pass, wherein a ferromagnetic steel ring is applied around these aperture edges of the biotope containers, on which ring magnetic closure caps, screen inserts or grille inserts with a magnetic edge or push-in parts adhere by means of holding magnets.

9. A universal holder for bars, tubes, ropes, bolts and suspension hooks on parts and components of the vivarium system of claim 1, consisting of base disc, one or more spacer bars, one or more intermediate parts with through bore transverse to the rod axis, end part and top disc, characterized in that high-performance magnets are embedded in a tension- and compression-resistant manner in the base plate and/or in the top disc and the magnetic adhesion and contact surface is coated with a special coating which increases the friction in the adhesion surface.

10. A plant container in dimensions adapted to the vivarium system according to claim 1, characterized in that on the back, strong magnets are installed in the vessel wall at the top and bottom, and in this region a thin non-slip coating made of silicone, rubber, or special plastic is applied on the outer wall.
